(19) United States
(12) Patent Application Publication
(10) Pub. No.: US 2016/0334621 A1
(43) Pub. Date: Nov. 17, 2016

(54) DESIGN METHOD FOR OPTICAL ELEMENT, AND OPTICAL ELEMENT ARRAY

(71) Applicant: CANON KABUSHIKI KAISHA, Tokyo (JP)

(72) Inventors: Kazunari Kawabata, Kawasaki-shi (JP); Jun Iba, Yokohama-shi (JP)

(21) Appl. No.: 15/137,474

(22) Filed: Apr. 25, 2016

(30) Foreign Application Priority Data
May 14, 2015 (JP) 2015-099512

(51) Int. Cl. G02B 27/00; G02B 3/00

(52) U.S. Cl. CPC G02B 27/0012; G02B 3/0043; G02B 3/0056

(57) ABSTRACT

A design method for an optical element arranged in correspondence with a corresponding one of a plurality of pixels arranged in a matrix pattern to form a pixel array and configured to focus light. The method comprises selecting a first optical element whose information concerning a shape is known and which is arranged at a position close to the center of the pixel array and a second optical element whose information concerning a shape is known and which is arranged closer to the periphery of the pixel array than the first optical element, and determining information concerning a shape of a third optical element arranged at a position different from positions of the first optical element and the second optical element by using the information concerning the shape of the first optical element and the information concerning the shape of the second optical element.

### BACKGROUND OF THE INVENTION

1. Field of the Invention

The present invention relates to a design method for an optical element used in an image capturing apparatus, and an optical element array including an optical element designed by the design method.

2. Description of the Related Art

Some sensor array has a plurality of pixels arranged in a matrix pattern and a microlens provided, as an optical element for focusing light, on the upper side of each photoelectric conversion element. The incident angle at which light is incident on each photoelectric conversion element through an imaging lens changes depending on the position on the sensor array. Japanese Patent Laid-Open No. 2006-49721 has proposed an image capturing apparatus which improves a sensitivity characteristic by changing the shape of an optical element arranged in correspondence with a photoelectric conversion element in accordance with the position on a sensor array.

### SUMMARY OF THE INVENTION

According to the first aspect of the present invention, there is provided a design method for an optical element arranged in correspondence with a corresponding one of a plurality of pixels arranged in a matrix pattern to form a pixel array and configured to focus light, the method comprising, selecting a first optical element whose information concerning a shape is known and which is arranged at a position close to the center of the pixel array and a second optical element whose information concerning a shape is known and which is arranged closer to the periphery of the pixel array than the first optical element, and determining information concerning a shape of a third optical element arranged at a position different from positions of the first optical element and the second optical element by using the information concerning the shape of the first optical element and the information concerning the shape of the second optical element.

Further features of the present invention will become apparent from the following description of exemplary embodiments with reference to the attached drawings.

### BRIEF DESCRIPTION OF THE DRAWINGS

FIGS. 1A to 1C are schematic views for explaining an outline of a design method for an optical element according to an embodiment;

FIG. 2 is a flowchart showing a procedure for the design method for an optical element according to the embodiment;

FIG. 3 is a schematic view for explaining a design method for an optical element according to the first embodiment;

FIG. 4 is a schematic view for explaining the design method for an optical element according to the first embodiment;

FIG. 5 is a schematic view for explaining the design method for an optical element according to the first embodiment;

FIG. 6 is a schematic view for explaining the design method for an optical element according to the first embodiment;

FIGS. 7A to 7C are schematic views each showing the shape of an optical element designed by the design method for an optical element according to the first embodiment;

FIG. 8 is a schematic view for explaining the design method for an optical element according to the second embodiment;

FIGS. 9A and 9B are schematic views for explaining the design method for an optical element according to the second embodiment;

FIG. 10 is a flowchart showing a procedure for the design method for an optical element according to the second embodiment;

FIG. 11 is a view showing an effect of the design method for an optical element according to the second embodiment;

FIG. 12 is a schematic view for explaining a design method for an optical element according to the third embodiment;

FIG. 13 is a view showing an effect of the design method for an optical element according to the third embodiment;

FIGS. 14A to 14C are schematic views for explaining a design method for an optical element according to the sixth embodiment; and

FIG. 15 is a sectional view schematically showing an example of the arrangement of a sensor array according to an embodiment of the present invention; and

FIG. 16 is a block diagram of an image capturing apparatus according to an embodiment of the present invention.

### DESCRIPTION OF THE EMBODIMENTS

### First Embodiment

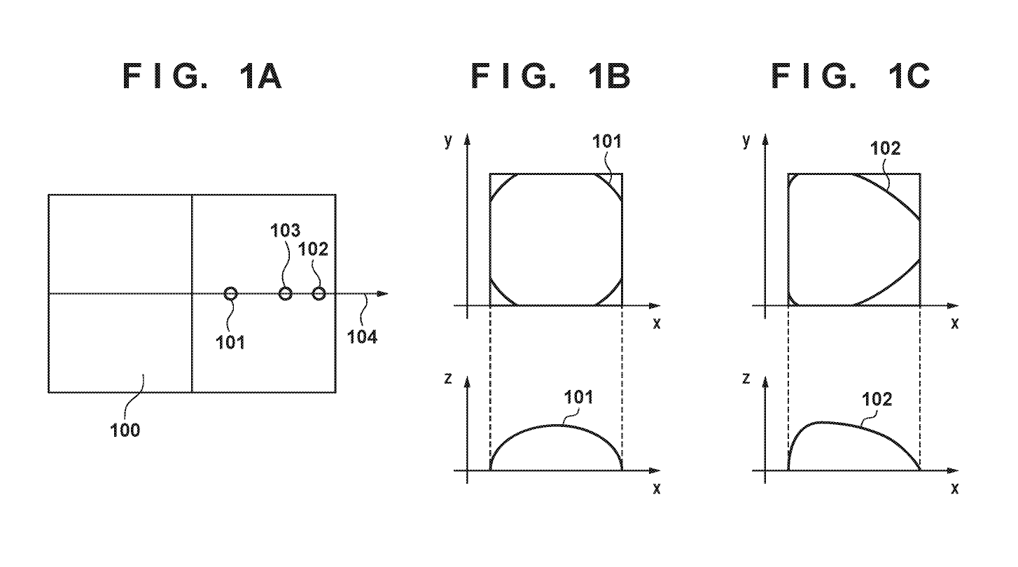

FIGS. 1A to 1C are schematic views for explaining an outline of a design method for an optical element according to each embodiment of the present invention. An optical element according to each embodiment is provided on the sensor array of an image capturing apparatus. That is, pixels including a plurality of photoelectric conversion elements are arranged in a matrix pattern on the sensor array of the image capturing apparatus to form a pixel array. In addition, a plurality of optical elements (microlenses) are formed to overlap the plurality of photoelectric conversion elements. FIG. 1A is a top view of a sensor array 100, of the image capturing apparatus, on which pixels are arrayed. Assume that in this embodiment, a first optical element 101 and a second optical element 102 are located on a virtual straight line 104 extending from the center of the sensor array 100 to its outer circumferential portion. The first optical element 101 is located on a side close to the center of the sensor array 100. Assume that the second optical element 102 is located closer to the periphery of the sensor array 100 than the first optical element 101. Assume also that the first optical element 101 and the second optical element 102 have different shapes.

In general, the incident angle at which a light beam reaches a sensor surface through the imaging lens changes depending on the position on the sensor array 100. This makes it possible to improve light collection performance and sensitivity characteristics by changing the shape of an optical element in accordance with the position on the sensor array 100. This point will be described below. FIGS. 1B and 1C are views schematically showing, as an example, the bottom shapes and cross-sectional shapes of the two optical elements 101 and 102 in the height direction on the virtual straight line 104. As shown in FIG. 1B, the first optical element 101 located at a position close to the center of the sensor array 100 is a spherical microlens having a bottom surface with a symmetrical shape. That is, the first optical element 101 is formed to have shape suitable for light which is incident on a sensor surface, on which the sensors of the sensor array are arranged, at a nearly vertical angle. In contrast, as shown in FIG. 1C, the second optical element 102 located on a peripheral side of the sensor array 100 is a microlens having an asymmetrical shape, such as a prism, whose highest position shifted to the center of the sensor array 100. This enables the second optical element 102 to refract light obliquely incident on the sensor surface in a direction closer to the vertical direction than the first optical element 101 formed to have a symmetrical shape. The second optical element 102 can therefore efficiently guide obliquely incident light to the light-receiving surface. The first optical element 101 and the second optical element 102 have different shapes in this manner.

In this arrangement, in order to prevent unevenness of sensitivity from being caused in the sensor array 100, the shape of an optical element is preferably continuously changed from the central portion of the sensor array 100 to the periphery. It is practically difficult to design the shapes of optical elements respectively provided for several tens of thousands to several tens of millions of pixels. In this embodiment, information concerning a position (coordinate) in the first optical element 101 and a shape concerning a height at the position (coordinate) is known, and likewise information concerning the shape of the second optical element 102 is known. Information concerning the shape of a third optical element 103 arranged between the optical elements 101 and 102 is obtained based on the information concerning these shapes. This makes it possible to generate an optical element whose shape continuously changes with respect to a pixel at any position on the sensor array 100, and to greatly shorten the time required for the design of the optical element. Note that the virtual straight line 104 may be any straight line extending from a side near the center of the sensor array 100 to an outer side (peripheral side), and may extend in any direction from the center. In addition, the above description has exemplified the case in which an optical element having a symmetrical shape is used as the first optical element 101 located on the central side of the sensor array 100, and an optical element having an asymmetrical shape is used as the second optical element 102 located on the periphery. However, the present invention is not limited to this. For example, the first optical element 101 may have an asymmetrical shape. The second optical element 102 may have a symmetrical shape. Furthermore, both the first optical element 101 and the second optical element 102 may have symmetrical or asymmetrical shapes, or either of them may have a symmetrical or asymmetrical shape.

In addition, FIG. 1A shows a case in which the optical elements 101, 102, and 103 are orderly arranged on the virtual straight line 104. However, the third optical element 103 may be located at a position outside the virtual straight line 104 depending on how pixels are arranged or how the first and second optical elements are selected. In this case as well, information concerning the shape of the third optical element 103 may be determined based on information concerning the shapes of the optical elements 101 and 102. For example, information concerning a shape of the third optical element 103 can be obtained based on a position information at which the virtual straight line 104 passing through the first and second optical elements intersects with a straight line extending from the third optical element in a direction perpendicular to the virtual straight line 104. In this case, no serious trouble occurs in terms of light collection as long as the distance between the position where the above straight lines vertically intersect with each other and the position of the third optical element is equal to or less than a width corresponding to 20% of the number of pixels on a short side of the pixel array. In addition, information concerning the shape of the third optical element may be obtained based on a function passing through the first, second, and third optical elements.

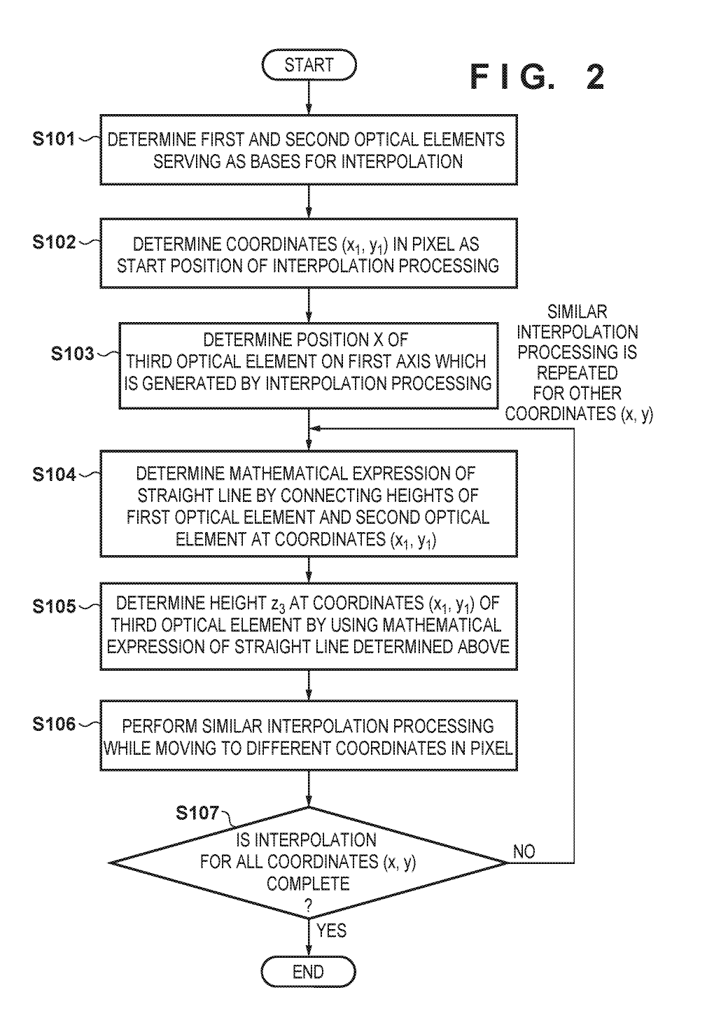

The following will describe a method of determining information concerning the shape of the third optical element 103 located between the two optical elements 101 and 102 by linear interpolation based on the heights of the two optical elements 101 and 102. FIG. 2 is a flowchart for a design method for an optical element according to the first embodiment of the present invention. This method will be described in accordance with this flowchart.

In step S101, the first optical element 101 and the second optical element 102 serving as references for interpolation are determined. For example, as the first optical element 101, an optical element located on a side close to the center of the sensor array 100 on the virtual straight line 104 is selected. As the second optical element 102, an optical element located closer to the periphery than the first optical element 101 is selected on the virtual straight line 104. As described above, assume that information concerning the shapes of the first and second optical elements is known.

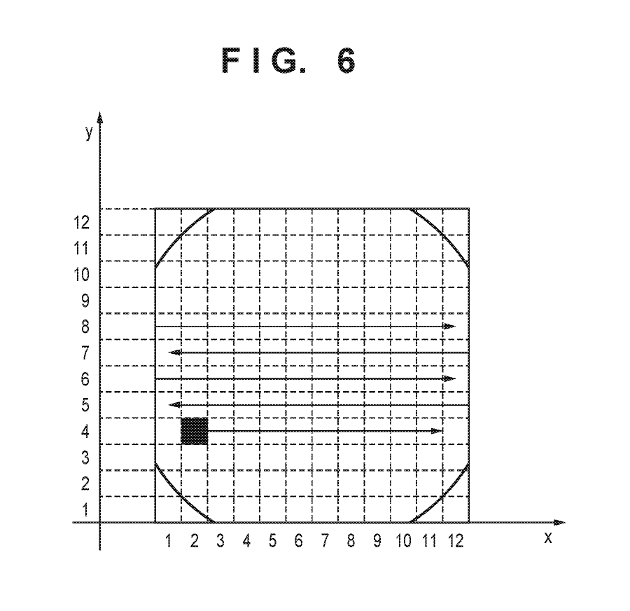

In step S102, coordinates as a start position in a pixel from which interpolation starts are determined, and interpolation is sequentially performed based on coordinates indicating a plurality of positions within one pixel. For example, as shown in FIG. 6, one pixel is divided into an I×J matrix, and the processing of obtaining information concerning the shape of the third optical element 103 is performed by using information concerning the shapes of the optical elements 101 and 102 for each divided rectangular region. Assume that the coordinates of each region are coordinates (xᵢ, yⱼ), where i=1 to I (I is the number of regions divided in the X-axis direction) and j=1 to J (J is the number of regions divided in the Y-axis direction). In the case shown in FIG. 6, pixels are partitioned into 12 rows×12 columns in the vertical and horizontal directions, and interpolation processing is sequentially performed within a pixel based on heights from the bottom surfaces of the optical elements 101 and 102 in the respective partitioned regions. It is possible to use a height from the center of each region or an average height within each region.

In step S103, a position x on the virtual straight line 104 of the third optical element 103 designed by interpolation processing is determined. In step S104, a height at the coordinates (xᵢ, yⱼ) within the pixel of each of the two optical elements 101 and 102 is obtained from information concerning a shape, and a mathematical expression representing a straight line virtually connecting between heights at the coordinates (xᵢ, yⱼ) of the optical elements 101 and 102 is obtained. In step S105, a height at the coordinates (xᵢ, yⱼ) of the third optical element 103 is calculated by using the mathematical expression determined in step S104.

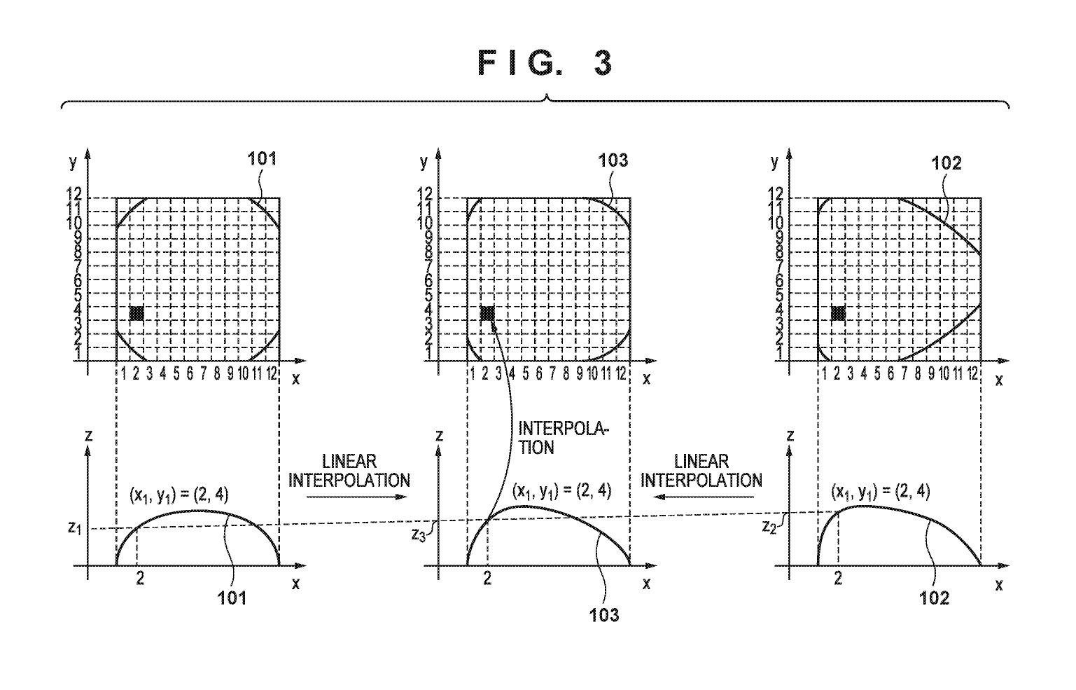

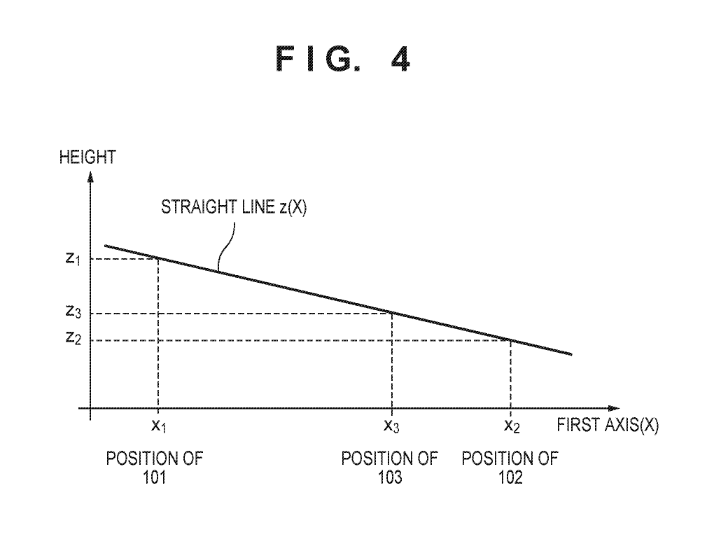

FIG. 3 is a schematic view for explaining the first embodiment of the design method for an optical element according to this embodiment. FIG. 4 is a schematic view showing a method of determining a height at the coordinates (x₁, y₁) of the third optical element 103 by linearly interpolating a height at the coordinates (x₁, y₁) of each of the two optical elements 101 and 102. In the case shown in FIG. 3, when designing the third optical element 103, heights at the same coordinate positions in pixels of the two optical elements 101 and 102 are linearly interpolated by a straight line. FIG. 3 shows a case in which a height z₃ at coordinates (2, 4) of the third optical element 103 is obtained from a height z₁ from the bottom surface at coordinates (2, 4) of the optical element 101 and a height z₂ at coordinates (2, 4) of the second optical element 102. In this case, the maximum heights of the two optical elements 101 and 102 are the same. As shown in FIG. 4, assume that the positions and heights of the two optical elements 101 and 102 within a plane of the sensor array 100 are respectively represented by (X₁, Z₁) and (X₂, Z₂). In this case, a height Z₃ at the coordinates (x₁, y₁) of the third optical element 103 in the sensor array 100 can be determined by using equation (1):

Z₃=(Z₁-Z₂)·X/(X₁-X₂)+(Z₂·X₁−Z₁·X₂)/(X₁-X₂) (1)

In this manner, equation (1) for obtaining the height Z₃ by interpolation in step S104 is determined. In step S105, a height at the coordinates (x₁, y₁) of the third optical element 103 is determined by equation (1).

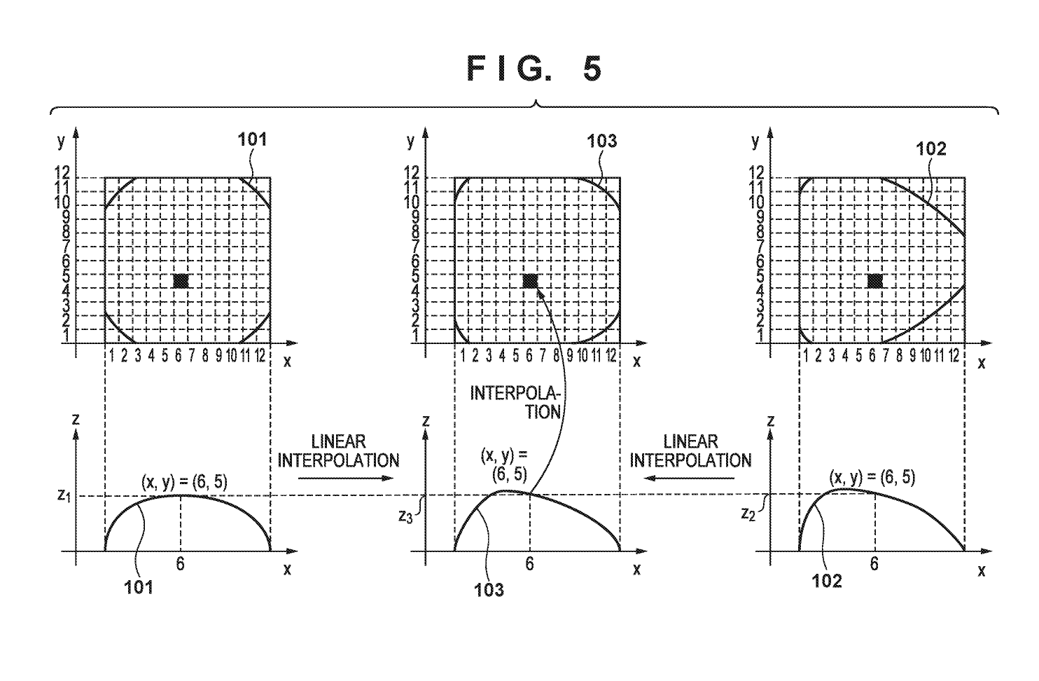

In step S106, it is determined whether the processing in step steps S104 and S105 has been executed with respect to all the coordinates (xᵢ, yⱼ). If there is any position at which the processing has not been executed, the process returns to step S104. The processing in steps S104 and S105 is then executed with respect to the position at which the processing has not been executed. FIG. 5 is a schematic view showing a case in which shape information of the third optical element 103 is determined based on the first optical element 101 and the second optical element 102 each located at a position (6, 5) different from that in FIG. 3.

FIG. 6 shows an example of a procedure for obtaining information concerning the shape of the third optical element 103. However, a processing procedure is not limited to this. If the processing has been executed with respect to all the positions, the design of the third optical element 103 is terminated.

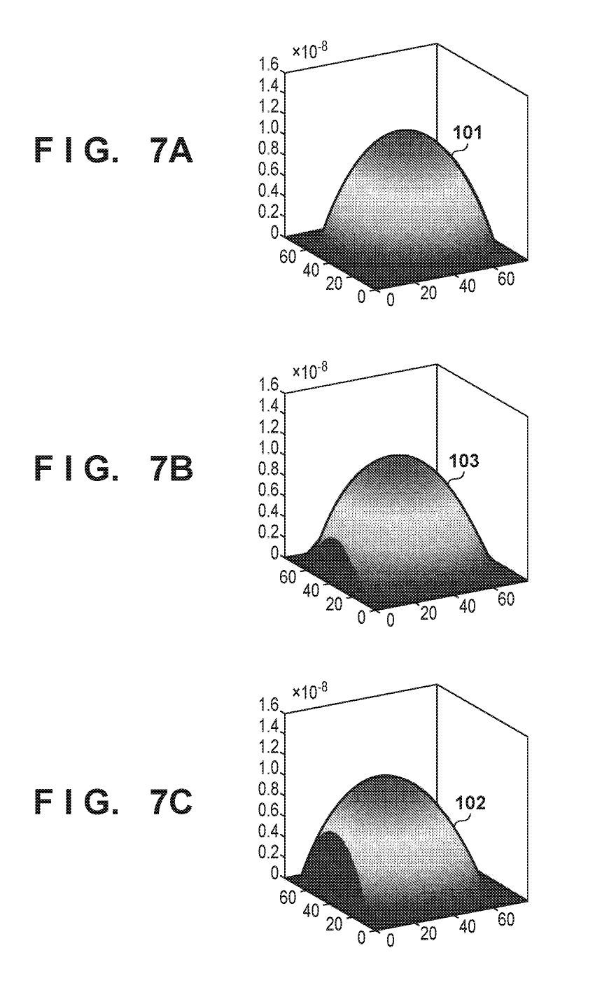

As described above, the shape of the third optical element 103 is uniquely determined by the shapes of the two optical elements 101 and 102 by obtaining information concerning the shape of the third optical element 103 at all the coordinates (xᵢ, yⱼ) (i=1 to I and j=1 to J) of the optical element 103. FIGS. 7A to 7C respectively show stereoscopic schematic views of the third optical element 103 designed in this manner and the two optical elements 101 and 102 whose shapes serve as references for interpolation. The third optical element 103 shown in FIG. 7B is an example of designing a shape by regarding that the optical element is located at a midpoint between the two optical elements 101 and 102.

The next will describe about design when the shapes of the bottom surfaces of the two optical elements 101 and 102 serving as references for interpolation processing greatly differ from each other, as shown in FIG. 5. In this case, the range of the bottom surface of the third optical element 103 generated by interpolation processing becomes sometimes broader than those of the two optical elements 101 and 102 to result in obtaining a shape, with some portion, of a portion abutting against the outer edge of a pixel, being low. In such a case, the shape may be corrected to reduce the height of an outer edge portion of the optical element to 0. For example, if the temporarily determined height of the shape of the third optical element 103 is partially lower than a predetermined threshold, the height of the portion is adjusted to 0. In this case, a threshold can be set to a height of about 0.1% to 10% of that of the highest portion of the third optical element 103.

This embodiment uses an optical element having a symmetrical shape as the first optical element 101 located on the central portion side of the sensor array 100, and uses an optical element having an asymmetrical shape as the second optical element 102 located on the periphery. However, the present invention is not limited to this arrangement. For example, the first optical element 101 may have an asymmetrical shape. In addition, the second optical element 102 may have a symmetrical shape. That is, both the optical elements 101 and 102 may have symmetrical or asymmetrical shapes, or either of them may have a symmetrical or asymmetrical shape. Even with such arrangement, the third optical element 103 can be designed by the same interpolation processing. For the two optical elements 101 and 102, shapes are selected, when the elements are arranged on pixels, so as to focus light on the corresponding pixels.

In addition, this embodiment has exemplified the case in which the shape of the third optical element between the first optical element and the second optical element is obtained by interpolation. The shape of the third optical element on a virtual straight line outside between the first optical element and the second optical element may be designed by extrapolation instead of interpolation. In this case as well, the shape of the third optical element can be determined by a height from the bottom surface. Equation (1) holds with an extrapolation method as well as an interpolation method, and hence it is possible to determine the shape of the third optical element on a virtual straight line outside between the first optical element and the second optical element based on equation (1). In this case, for example, it is possible to obtain information concerning the shape of the second optical element 102 based on information concerning the shapes of the optical elements 101 and 103 shown in FIG. 1 for which optical elements whose information concerning shapes is known are selected. If the information of shapes cannot be obtained concerning all the pixels by interpolation processing, information about the shapes of optical elements may be obtained by extrapolation. Even if the third optical element is located outside a virtual straight line, it is possible to determine the shape of the third optical element within a predetermined range from the virtual straight line as in the case using interpolation.

In addition, in this embodiment, the maximum heights of the two optical elements 101 and 102 are the same. However, the present invention is not limited to this arrangement. It is sometimes possible to suppress unevenness of sensitivity by setting the maximum heights of the respective optical elements to different values. For this reason, the maximum heights of the two optical elements 101 and 102 serving as references for interpolation or extrapolation may differ from each other.

In addition, in this embodiment, the number of regions into which the light-receiving surface of one pixel is divided in a matrix pattern is set to 144 (12×12). However, this number of regions divided is an example for the description of the embodiment. In practice, for example, one pixel can be divided into about 100 to 100,000 regions in a matrix pattern, or may be about 1,000 to 10,000 regions. This embodiment has exemplified the arrangement using a linear function for interpolation and extrapolation processing. However, a function to be used is not limited to a linear function. For example, processing may be performed by a mathematical expression using a higher-order function or trigonometric function. In consideration of incident light characteristics, in particular, it is more appropriate to use a cos (cosine function) or a function including a cos. In addition, if the third optical element exhibits no predetermined performance, the mathematical expression to be used in processing may be changed or the first and second optical elements selected previously may be changed to optical elements having other shapes.

In order to design the shapes of all the optical elements of a sensor array by using such interpolation or extrapolation, for example, first of all, the third optical element is designed by using the first optical element 101 and the second optical element 102 whose information concerning shapes is known. Thereafter, two known optical elements are selected and arranged on another straight line, and the third optical element is designed by handling the two optical elements as the first and second optical elements. All the optical elements on the sensor array can be designed by sequentially performing the above processing. Alternatively, for example, equation (1) may be obtained based on the first and second optical elements whose information concerning shapes is known, and an optical element at a position on a virtual straight line extending from the center of the sensor array to the periphery of the sensor array in a radial direction may be designed by using equation (1). In this case, using equation (1) with the distance from the center to a given pixel being a variable can design an optical element corresponding to the pixel. For example, calculation may be performed on the assumption that the first optical element whose information concerning shape is known is arranged at the origin of the coordinate system.

In addition, in order to design all optical elements, design is performed by using processing based on extrapolation or interpolation having an inclination (to be described later) instead of processing based on interpolation, or using characteristics such as the symmetry of the arrangement of pixels arranged on a sensor array or the distances between pixels in interpolation or extrapolation processing. In this manner, the shapes of optical elements included in an optical element array arranged in a sensor array can be obtained by using a small number of known optical elements. The processing of obtaining information concerning the shapes of other third optical elements will be described below.

### Second Embodiment

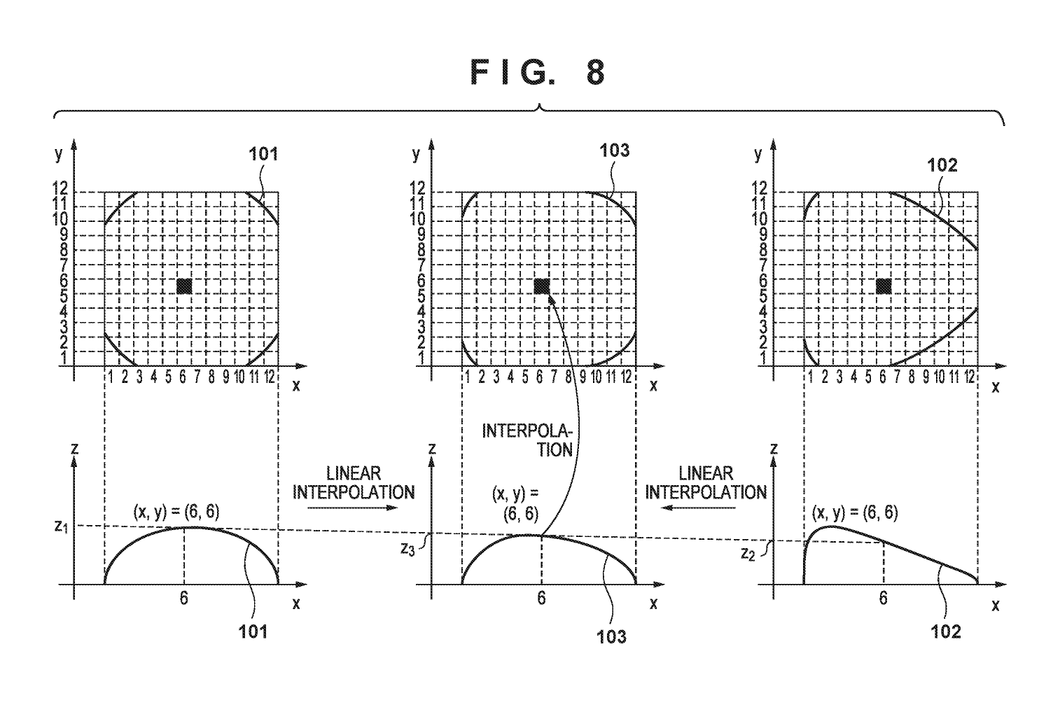

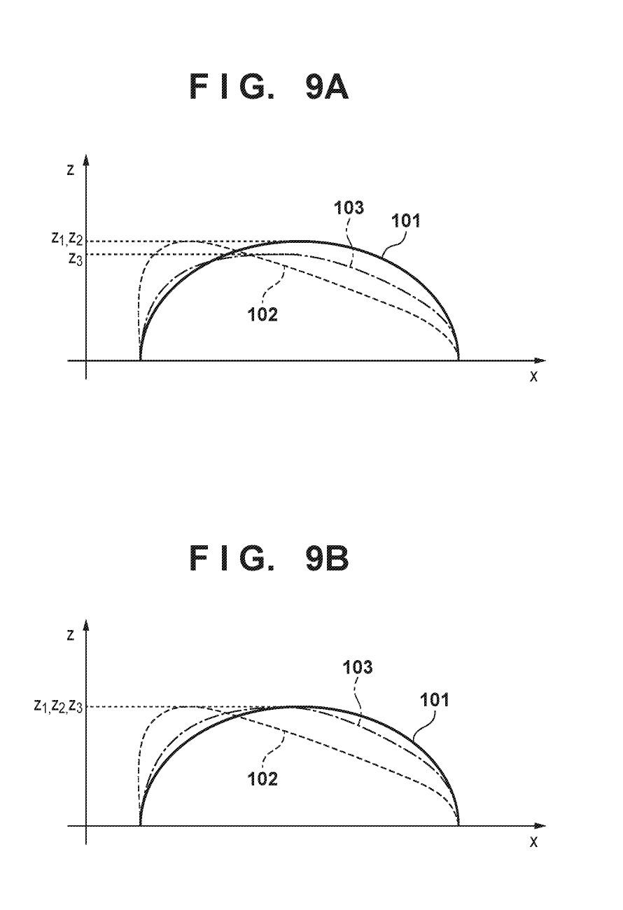

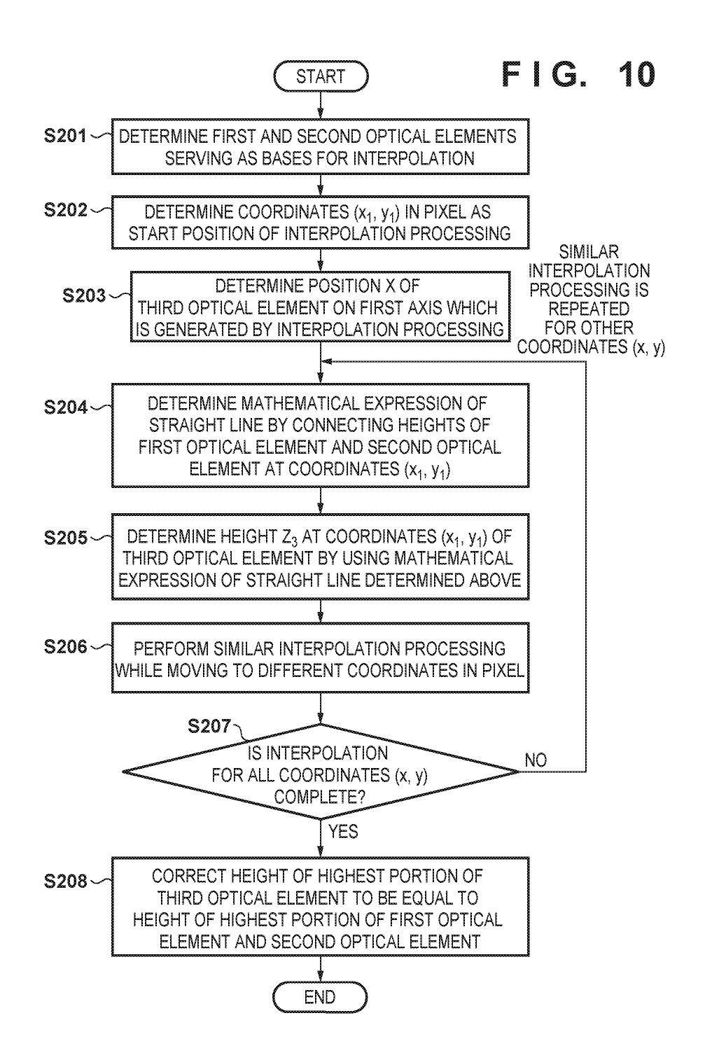

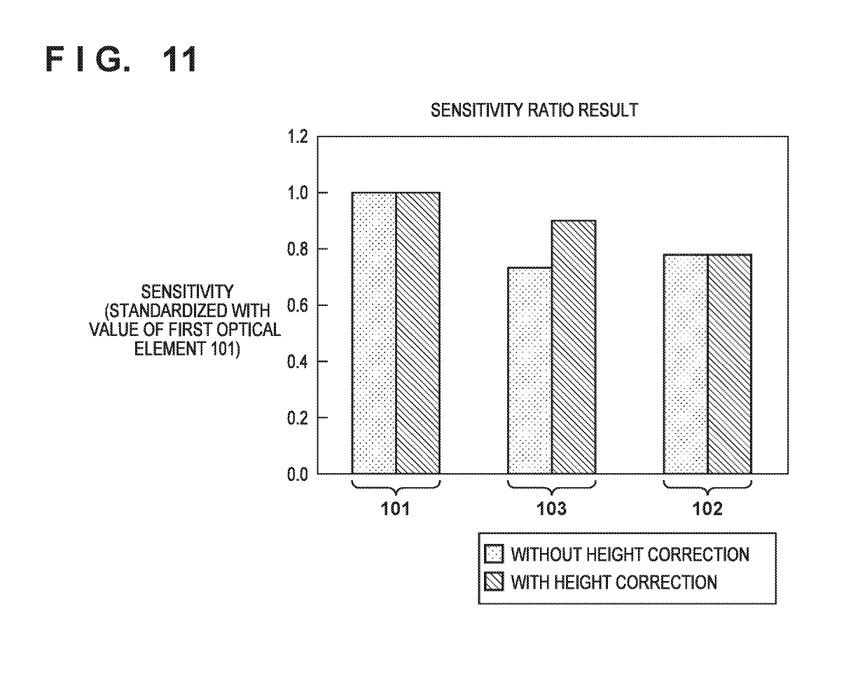

The second embodiment of the present invention will be described next with reference to FIGS. 8 to 11. This embodiment will exemplify a case in which information concerning the shape of the third optical element which is temporarily determined is corrected. FIG. 8 is a schematic view showing a method of obtaining the height of a third optical element 103 by linearly interpolating the heights of two optical elements 101 and 102. FIGS. 9A and 9B are schematic views showing a procedure for correcting the height of the third optical element 103. Note that FIG. 9A is a view showing the third optical element 103 before correction while being superimposed on the two optical elements 101 and 102. As shown in FIG. 9A, the maximum heights of the optical elements 101 and 102 are the same. FIG. 9B shows the third optical element 103 after correction while being superimposed on the two optical elements 101 and 102. FIG. 10 is a flowchart showing a procedure for a design method according to the second embodiment. FIG. 11 is a graph showing the result of comparing, by simulation, the sensitivities of pixels corresponding to the optical elements 101, 102, and 103 when no height correction is performed with those when height correction is performed.

In this embodiment, as in the first embodiment, the heights of the two optical elements 101 and 102 are linearly interpolated first, and then the height of the third optical element 103 located between them is determined. In this embodiment, the determined maximum height of the third optical element 103 is corrected to be equal to the maximum heights of the two optical elements 101 and 102.

In the first embodiment, the heights of the two optical elements 101 and 102 are linearly interpolated to determine the shape of the third optical element 103. In this case, if the positions of the highest portions of the two optical elements 101 and 102 differ from each other in coordinates in pixels, a maximum height z3 of the third optical element 103 is sometimes smaller than maximum heights z1 and z2 of the two optical elements 101 and 102, as shown in FIG. 9A. This arrangement sometimes deteriorates in light collection efficiency with respect to obliquely incident light. In this embodiment, therefore, the height of the third optical element 103 is corrected to the same maximum heights of the two optical elements 101 and 102 by proportionally multiplying heights at the respective positions in the pixel. That is, if the maximum height of the designed third optical element 103 is 1/N times that of the two optical elements 101 and 102, the height of the third optical element 103 at each position is corrected by being multiplied by N. This suppresses a deterioration in sensitivity caused by a lack of height of the third optical element 103 within a plane of a sensor array 100.

A procedure for design will be described briefly below. As shown in FIG. 10, steps S201 to S206 are the same as steps S101 to S106 in the first embodiment. If interpolation processing with respect to all positions has been completed in step S207, the process advances to step S208. In step S208, as described above, the height of the third optical element 103 is corrected. This arrangement can improve sensitivity and obtain the effect of preventing unevenness of sensitivity within a plane of the sensor array 100 as compared with the case in which no height correction is performed, as shown in FIG. 11. Obviously, this embodiment can be applied to a case in which the shape of the third optical element is obtained by extrapolation.

### Third Embodiment

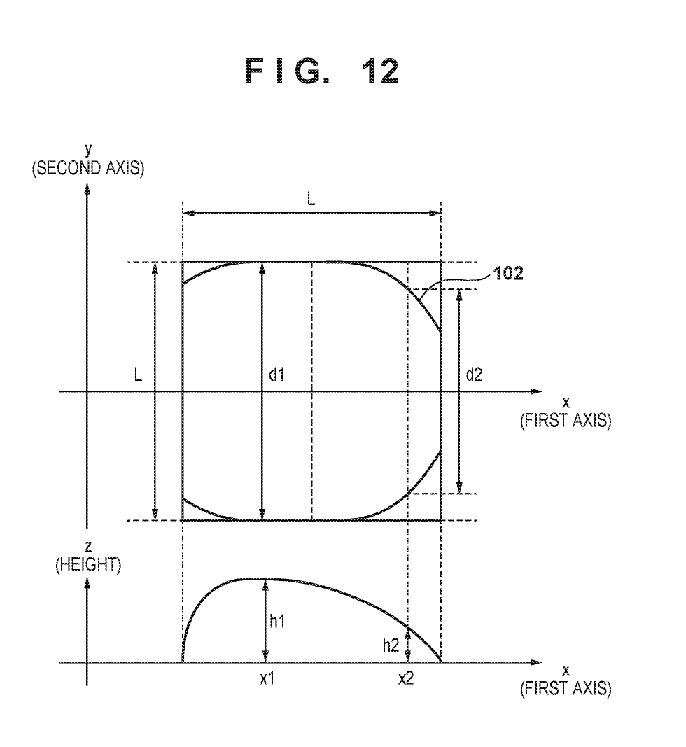

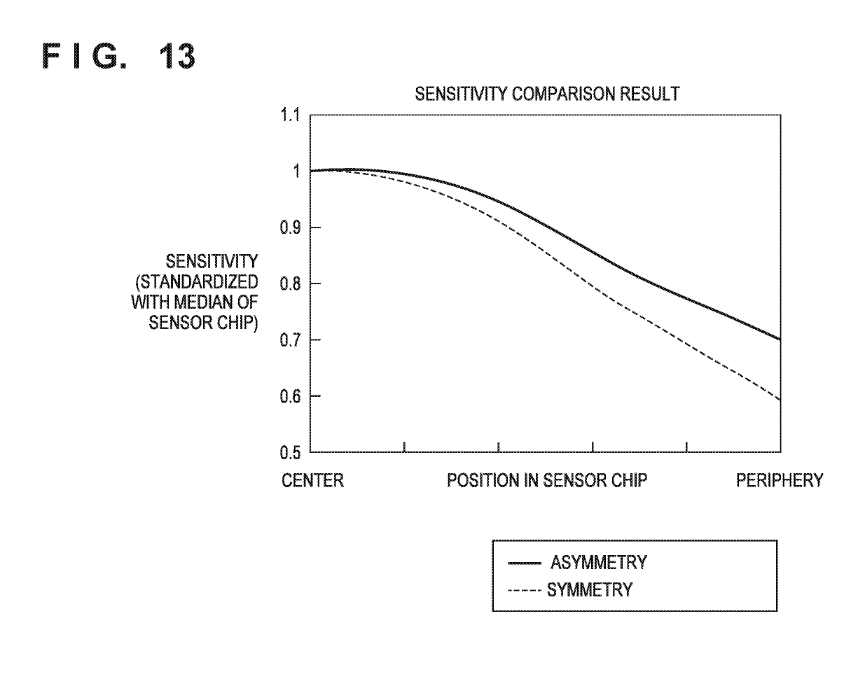

The third embodiment will be described next with reference to FIGS. 12 and 13. FIG. 12 shows a top view of an example of the arrangement of a second optical element 102, of two optical elements 101 and 102 serving as references for interpolation, which is located on the peripheral side of a sensor array 100, and a sectional view of the second optical element 102 along a virtual straight line 104. As shown in FIG. 12, as the second optical element 102, an optical element formed to have an asymmetrical shape, for example, a teardrop shape, is selected to be suited to improve characteristics with respect to oblique incident light. For example, letting L be a pixel pitch, the height (h2) of the second optical element 102 at a position (x₂>L/2) on the peripheral side of the sensor array 100 is smaller than a height (h1) of the second optical element 102 at a position (x₁<L/2) on the central portion side of the sensor array 100. Forming the second optical element 102 into an asymmetrical shape so as to have a large curvature on the light incident side in this manner can vertically refract obliquely incident light. Therefore, selecting an optical element having such a shape as the second optical element can more efficiently guide light to the photoelectric conversion element than an optical element having a symmetrical shape. This can improve sensitivity.

The second optical element 102 has a bottom surface including the virtual straight line 104 and the second axis perpendicular to it. A width (a dimension in the second-axis direction) (d2) of the bottom surface of the second optical element 102 at the second position (x2) on the peripheral side of the light-receiving region is smaller than a width (d1) at the first position (x1) on the central side of the sensor array 100 with respect to the center of the pixel. Alternatively, the width of the bottom surface of the second optical element 102 is measured in a direction perpendicular to a straight line perpendicular to a symmetrical axis with respect to a short side of the sensor array. The width (d2) of the bottom surface at the second position (x2) on the peripheral side of the light-receiving region is smaller than the width (d1) at the first position (x1) on the central side of the sensor array 100 with respect to the center of the pixel. This can also make an end portion on the peripheral side of the virtual straight line 104, on which the height becomes small, have a large curvature in a direction perpendicular to the virtual straight line 104 of the second optical element 102. The above arrangement concerning the width of the bottom surface can refract light obliquely incident on the end portion of the light-receiving region in a vertical direction throughout nearly the entire surface of one pixel. This therefore improves light collection efficiency with respect to light incident on the end portion.

FIG. 13 is a graph showing an optical characteristic evaluation result when the second optical element 102 serving as references for interpolation, of the two optical elements 101 and 102, which is located on the peripheral side of the sensor array 100 has a shape like that shown in FIG. 12 described above. Note that FIG. 13 also shows, as a comparison target, an optical characteristic evaluation result when the second optical element 102 on the peripheral side of the sensor array 100 has a symmetrical shape. As shown in FIG. 13, the evaluation result according to this embodiment exhibited an improvement in sensitivity by 10% to 20% on the end portion of the sensor array 100 as compared with the case using the optical element having the symmetrical shape. In addition, the embodiment obtained the effect of improving a luminance shading characteristic from the center of the sensor array 100 to the periphery.

An optical element which properly focuses light on a pixel can be obtained by selecting an optical element having information concerning the shape according to this embodiment as the second optical element and obtaining information concerning the shape of the third optical element by design. In addition, the third optical element may be designed by extrapolation using the second optical element according to the embodiment.

### Fourth Embodiment

In this embodiment, first of all, a third optical element 103 located between two optical elements 101 and 102 serving as references for interpolation is designed from the two optical elements. An optical element located between the optical elements 101 and 103 is designed by interpolation processing using the first optical element 101, of the two optical elements, which is located close to the center of the sensor array 100, and the shape of the third optical element 103 obtained by the interpolation processing. That is, the obtained information concerning the shape of the third optical element 103 is handled as the information concerning the shape of the second optical element 102 to perform interpolation processing when designing another optical element. Obviously, this embodiment may be used to determine the shape of another optical element by extrapolation processing.

### Fifth Embodiment

In this embodiment, based on information concerning an optical element obtained by design, the shape of an optical element at another position on the sensor array is designed by performing the processing according to one of the first to fourth embodiments. First of all, a third optical element 103 located between two optical elements 101 and 102 is designed based on the two optical elements as references for interpolation. An optical element located between the optical elements 101 and 103 is designed by interpolation processing by using the first optical element 101, of the two optical elements 101 and 102, which is located close to the center of a sensor array 100 and the designed third optical element 103. Likewise, another optical element located between the two optical elements 102 and 103 is designed by interpolation processing using the second optical element 102, of the two optical elements 101 and 102, which is located on the peripheral side of the sensor array 100 and the designed third optical element 103. That is, the designed third optical element 103 is used as the first optical element 101 when designing another optical element. Likewise, the designed third optical element 103 is used as the second optical element 102 when designing another optical element. The shape of this optical element may be obtained by extrapolation.

### Sixth Embodiment

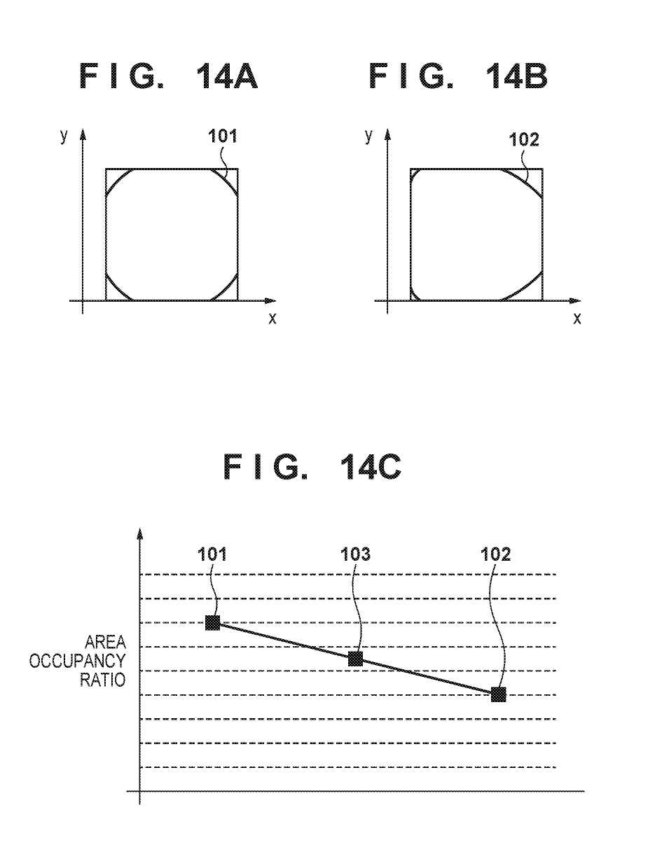

This embodiment will exemplify a case in which a temporarily designed third optical element 103 is designed such that its area occupancy ratio continuously changes with respect to the area occupancy ratios of two optical elements 101 and 102 serving as references for interpolation. FIGS. 14A and 14B schematically show the bottom surface shapes of the two optical elements 101 and 102 serving as references for interpolation. First of all, the third optical element 103 located between the two optical elements 101 and 102 is designed based on the two optical elements 101 and 102. The bottom surface shape of the third optical element 103 is corrected by being enlarged or reduced such that the area occupancy ratio of the optical element 103 exhibits a linear relation with the area occupancy ratios of the first optical element 101 and the second optical element 102 with respect to the distances between the respective optical elements. In this embodiment, the bottom surface shape is corrected so as to linearly and continuously change its area in accordance with the distance. Performing such processing can linearly change the area occupancy ratio of the optical element in a plane of a sensor array 100, as shown in FIG. 14C. This arrangement can continuously change the light collection efficiency of an optical element within the plane of the sensor array 100, thereby obtaining the effect of preventing unevenness of sensitivity in the plane. Note that an area occupancy ratio in this case indicates, for example in FIG. 14A, the ratio of the bottom surface area of the first optical element 101 to the area of one pixel. If pixels have the same dimensions, the area occupancy ratio of each optical element is in proportion to the bottom surface area of the optical element. In addition, it is possible to use another function whose value continuously changes in accordance with a variable for correction.

In addition, a linear change in area occupancy ratio includes a case in which the optical elements 101, 103, and 102 have the same area occupancy ratio. In this case as well, since the light collection performance of an optical element can be continuously held in a plane of the sensor array 100, unevenness of sensitivity within the plane can be prevented. The same effect can be obtained regardless of whether the optical elements 101 and 102 in the sensor array 100 have either symmetrical or asymmetrical shapes. This processing may be applied to an optical element obtained by extrapolation processing.

### Seventh Embodiment

This embodiment is directed to a case in which a third optical element 103 is formed between a first optical element 101 and a second optical element 102. The shape of the third optical element 103 is determined such that the inclination of a straight line connecting the heights of arbitrary two optical elements of these three optical elements at the same coordinates in pixels coincides with the inclination of a straight line obtained with respect to the two other optical elements. Let a be the pitch (size) of pixels, x₁ be the coordinates of an arbitrary position on a virtual straight line on which the first optical element 101 is arranged on the surface of the sensor array, and n₂ be an arbitrary integer which is a value determined by the number of pixels between the second optical element 102 and the first optical element 101 on the virtual straight line. If, therefore, the coordinates of the first optical element 101 are represented by x₁, the coordinates of the second optical element 102 corresponding to x1 of the first optical element are represented by x₁+n₂·a. Therefore, a straight line passing through the first optical element 101 and the second optical element 102 is represented by equation (2) given below, with x representing arbitrary coordinates on a virtual straight line. Note that h(x) represents a function representing a height at a position x, and h(x₁) represents a height at the coordinates x₁.

According to this embodiment, the inclinations of straight lines respectively obtained concerning the optical elements 101 and 103, the optical elements 101 and 102, and the optical elements 102 and 103 are made to coincide with each other. That is, these inclinations are made to satisfy equation (3). In this case, n₂ represents an arbitrary integer indicating by how many pixels the second optical element 102 is separated from the coordinates x₁ of the first optical element 101, and n₁ represents an arbitrary number indicating by how many pixels the third optical element 103 is separated from the first optical element 101. This made it possible to obtain continuous sensitivity in a plurality of pixels in which different optical elements are arranged. Assume that the first optical element 101 is located on the central side on a virtual straight line, the second optical element 102 is located on the peripheral side, and the third optical element 103 is located between the first optical element 101 and the second optical element 102. In this case, n₂>n₁. In addition, if n₂<n₁, the third optical element 103 is located closer to the periphery than the second optical element 102, and the shape of the third optical element 103 can be designed by extrapolation. Note that the first optical element 101 may be arranged closer to the periphery than the center, and the second optical element 102 may be arranged closer to the periphery than the first optical element 101.

$$\begin{matrix}h ( x ) = ( h ( {x}_{1} + {n}_{2} \cdot a ) - h ( {x}_{1} ) ) \cdot ( x - {x}_{1} ) / ( {n}_{2} \cdot a ) + h ( {x}_{1} ) & ( 2 ) \\ \begin{matrix}( \begin{matrix}h ( {x}_{1} + {n}_{1} \cdot a ) - \\ h ( {x}_{1} )\end{matrix} ) / ( {n}_{1} \cdot a ) = ( h ( {x}_{1} + {n}_{2} \cdot a ) - h ( {x}_{1} ) ) / ( {n}_{2} \cdot a ) \\ = ( \begin{matrix}h ( {x}_{1} + {n}_{2} \cdot a ) - \\ h ( {x}_{1} + {n}_{1} \cdot a )\end{matrix} ) / ( ( {n}_{2} - {n}_{1} ) \cdot a )\end{matrix} & ( 3 )\end{matrix}$$

### Eighth Embodiment

Like the seventh embodiment, the eighth embodiment is directed to a case in which information concerning the shape of a third optical element 103 is obtained based on a straight line virtually connecting optical elements 101 and 102. In this embodiment, the inclination of a straight line obtained based on equation (2) differs depending on a position in a pixel. For example, the inclination obtained in the seventh embodiment is changed when the optical element is located within a distance half that between the center and the outer edge of a sensor array and when the optical element is located at a distance larger than half that between the center and the outer edge of the sensor array. The second optical element 102 is selected such that the inclination of a straight line when an optical element is located within a distance half that between the center and the outer edge is smaller than the inclination when the optical element is located at a distance larger than half the distance between the center and the outer edge. This increases the inclination of the surface of the optical element at a position distant from the central portion, thus increasing the curvature of a lens. This makes it possible to obtain continuous sensitivity while maintaining a good light collection efficiency with respect to obliquely incident light on the periphery of the sensor array.

The design methods for optical elements have been described above in the first to eighth embodiments. Any of these methods can be used for processing based on extrapolation like the method based on interpolation.

### Ninth Embodiment

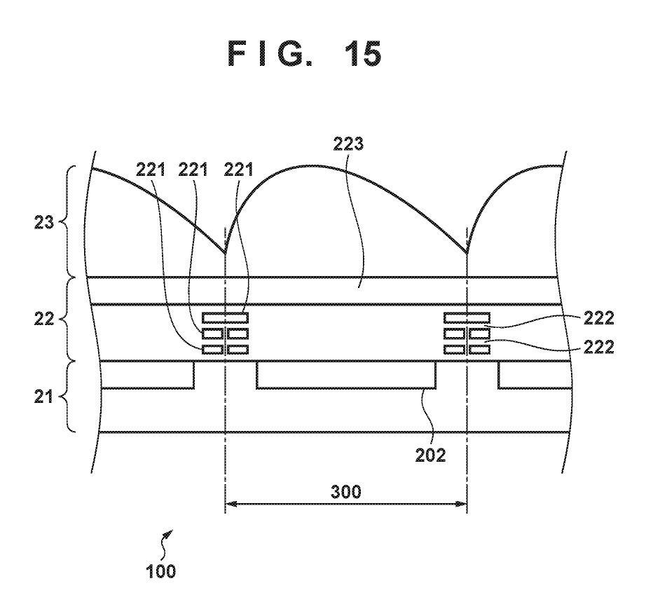

This embodiment is directed to an image sensor having optical elements, which are designed based on any of the first to eighth embodiments, and arranged as an optical element array. FIG. 15 is a sectional view schematically showing an example of the arrangement of a sensor array 100 to which optical elements designed by the above design method are applied. FIG. 15 shows part of the sensor array 100. As shown in FIG. 15, the sensor array 100 has a stacked structure including a semiconductor substrate 21, an intermediate layer 22 provided on the surface of the semiconductor substrate 21, and an optical element array 23 provided on the surface of the intermediate layer 22.

Circuits forming pixels 300 are two-dimensionally arrayed on the semiconductor substrate 21. Each pixel 300 includes, for example, a photoelectric conversion element 202, a switching element (transistor) which transfers charges generated by the photoelectric conversion element 202, a capacitor to which the charges are transferred, and a switching element (transistor) which outputs the charges in the capacitor to the outside. The switching element which outputs the charges in the capacitor to the outside is connected to a constant current source and a potential supply unit via a signal line. This arrangement can output the potential of the capacitor to the signal line.

The intermediate layer 22 is provided with a plurality of wiring layers 221, insulating layers 222 which insulate the wiring layers 221 from each other, a color filter layer 223 which separates colors, and the like. The intermediate layer 22 may further be provided with an interlayer lens layer and a light-shielding layer. The optical element array 23 is formed by arranging optical elements designed by the design method described in each embodiment in a matrix pattern. Each optical element of the optical element array 23 is provided at a position corresponding to a corresponding one of the pixels 300 on the semiconductor substrate 21 in a planar view. Note that the arrangement of an image capturing apparatus 2 is not limited to the above arrangement. That is, it is possible to use any arrangement which includes the semiconductor substrate 21 on which the plurality of pixels 300 including photoelectric conversion elements are arranged in a matrix pattern, and is provided with optical elements at positions corresponding to the pixels 300 on the surface of the substrate.

### Tenth Embodiment

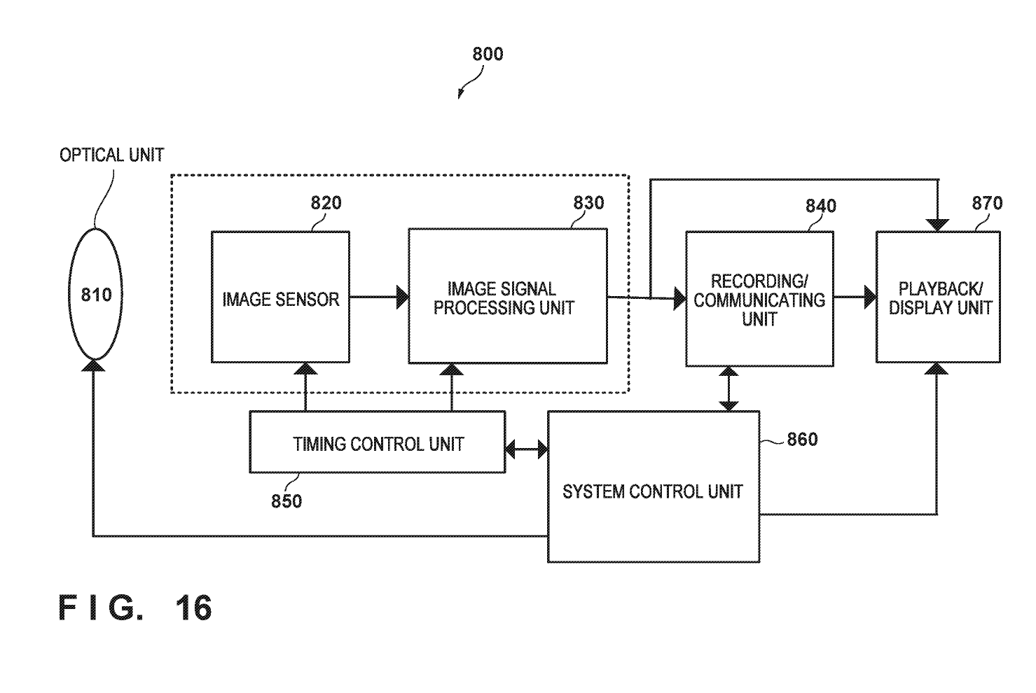

FIG. 16 is a block diagram showing an example of the arrangement of an image capturing system. An image capturing system 800 includes, for example, an optical unit 810, an image sensor 820, an image signal processing unit 830, a recording/communicating unit 840, a timing control unit 850, a system control unit 860, and a playback/display unit 870. The image sensor 820 includes the sensor array 100 described in the preceding embodiments.

The optical unit 810 as an optical system such as a lens forms an image of an object on a pixel unit on which a plurality of pixels of the image sensor 820 are arranged in a matrix pattern. The image sensor 820 outputs a signal corresponding to the light formed into the image on the pixel unit at a timing based on a signal from the timing control unit 850. The output signal from the image sensor 820 is input to the image signal processing unit 830. The image signal processing unit 830 then processes the signal in accordance with a method preset by a program and the like. The signal obtained by the processing performed by the image signal processing unit 830 is sent as image data to the recording/communicating unit 840. The recording/communicating unit 840 sends the signal for forming an image to the playback/display unit 870 to make it playback/display a moving image or still image. The recording/communicating unit 840 also communicates with the system control unit 860 upon receiving a signal from the image signal processing unit 830, and records the signal for forming the image on a recording medium (not shown).

The system control unit 860 comprehensively controls the operation of the image capturing system, and controls the driving of the optical unit 810, the timing control unit 850, the recording/communicating unit 840, and the playback/display unit 870. The system control unit 860 also includes a storage device (not shown), for example, a recording medium. Programs and the like required to control the operation of the image capturing system 800 are recorded on the storage device. In addition, the system control unit 860 supplies, for example, a signal for switching a driving mode in accordance with the operation of the user into the image capturing system. More specifically, for example, such signals include a signal for changing a row to be read out or reset, a signal for changing a field angle accompanying an electronic zooming operation, and a signal for shifting a field angle accompanying an electronic vibration control operation. The timing control unit 850 controls the driving timings of the image sensor 820 and the image signal processing unit 830 under the control of the system control unit 860.

Although the embodiments for carrying out the present invention have been described above, it is obvious that the present invention is not limited to them. Various modifications and changes of the embodiments can be made within the scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-099512, filed May 14, 2015, which is hereby incorporated by reference herein in its entirety.

What is claimed is:

1. A design method for an optical element arranged in correspondence with a corresponding one of a plurality of pixels arranged in a matrix pattern to form a pixel array and configured to focus light, the method comprising:
selecting a first optical element whose information concerning a shape is known and which is arranged at a position close to the center of the pixel array and a second optical element whose information concerning a shape is known and which is arranged closer to a periphery of the pixel array than the first optical element; and
determining information concerning a shape of a third optical element arranged at a position different from positions of the first optical element and the second optical element by using the information concerning the shape of the first optical element and the information concerning the shape of the second optical element.

2. The method according to claim 1, wherein a width of a bottom surface of the second optical element in a direction perpendicular to a virtual straight line extending from the center of the pixel array and passing through the second optical element becomes the largest on a side close to the center of the pixel array with respect to the center of a pixel on which the second optical element is arranged.

3. The method according to claim 1, wherein a height from a bottom surface of the second optical element becomes the largest on a side close to the center with respect to the center of the pixel on which the second optical element is arranged.

4. The method according to claim 1, wherein the determining the information concerning the shape of the third optical element includes determining a height from a bottom surface of the third optical element based on heights from bottom surfaces of the first optical element and the second optical element.

5. The method according to claim 1, wherein the determining the information concerning the shape of the third optical element includes determining a height from a bottom surface of the third optical element based on a straight line determined by heights from bottom surfaces of the first optical element and the second optical element.

6. The method according to claim 3, wherein the height from the bottom surface is a height from each of a plurality of regions virtually arranged in the pixel in a matrix pattern.

7. The method according to claim 6, wherein the number of the plurality of regions is 1,000 to 10,000.

8. The method according to claim 1, wherein the determining the information concerning the shape of the third optical element includes correcting a temporarily determined largest height from a bottom surface of the third optical element to be equal to a largest height among a height from a bottom surface of the first optical element and a height from a bottom surface of the second optical element.

9. The method according to claim 1, wherein the determining the information concerning the shape of the third optical element includes reducing a height, of a temporarily determined height from a bottom surface of the third optical element, which is smaller than a height obtained by multiplying a largest height from the bottom surface of the third optical element by a predetermined number to 0.

10. The method according to claim 1, wherein the determining the information concerning the shape of the third optical element includes obtaining a bottom surface area of the first optical element, a bottom surface area of the second optical element, and a temporarily determined value of a bottom surface area of the third optical element, and correcting the temporarily determined value of the bottom surface area of the third optical element so as to make the bottom surface area of the first optical element, the bottom surface area of the second optical element, and the value of the bottom surface area of the third optical element have a linear relation based on a distance between the first optical element and the second optical element and a distance between the first optical element and the third optical element.

11. The method according to claim 1, wherein the determining the information concerning the shape of the third optical element includes obtaining a bottom surface area of the first optical element, a bottom surface area of the second optical element, and a temporarily determined value of a bottom surface area of the third optical element, and correcting the value of the bottom surface area of the third optical element to be equal to the bottom surface area of the first optical element and the bottom surface area of the second optical element.

12. The method according to claim 1, further comprising determining information concerning a shape of another optical element from information concerning a shape of the first optical element or the second optical element and information concerning a shape of the third optical element.

13. An optical element array arranged in correspondence with a plurality of pixels arranged in a matrix pattern and configured to focus light, the array comprising
a first optical element arranged in the center of the plurality of pixels, a second optical element arranged on a periphery of the plurality of pixels, and a third optical element arranged between the first optical element and the second optical element,
wherein a height from a bottom surface of the first optical element, a height from a bottom surface of the second optical element, and a height from a bottom surface of the third optical element have a linear relation based on a distance between the first optical element and the second optical element and a distance between the first optical element and the third optical element.
